(19) United States
(12) Patent Application Publication
(10) Pub. No.: US 2025/0389556 A1
(43) Pub. Date: Dec. 25, 2025

(54) SENSOR DEVICES WITH OPTION MODULES

(71) Applicant: Rosemount Inc., Shakopee, MN (US)

(72) Inventors: Theodore H. SCHNAARE, New Prague, MN (US); Eric R. LOVEGREN, Monticello, MN (US); Jason H. RUD, Chanhassen, MN (US); Cory M. ROBINSON, Mayer, MN (US); Greg E. GINDELE, Maple Lake, MN (US); James A. JOHNSON, Savage, MN (US); Ryan C. TARRAS, Savage, MN (US)

(21) Appl. No.: 18/753,301

(22) Filed: Jun. 25, 2024

(51) Int. Cl. G01D 7/00; G01D 11/24

(52) U.S. Cl. CPC G01D 7/00; G01D 11/245; G01D 2207/30

(57) ABSTRACT

A sensor device includes a sensor module housing, a sensor module, a communication module, and a universal interface. The sensor module housing is configured to contain the sensor module. The sensor module disposed in the sensor module housing. A communication module is operably coupled to the sensor module. The universal interface configured to couple to an option module to provide an additional function. An extended sensor system is also provided.

### BACKGROUND

Industrial Internet of Things (IIoT) is rapidly developing to provide ease of connected instrumentation for monitoring and control of legacy applications and those that have historically been challenging to access. Wireless sensors and/or transmitters play an important role in IIOT by providing low cost, easy to connect field devices for both process parameter monitoring and to control actuators.

In process instrumentation and control, it is known to provide high-tier, feature-rich field devices to monitor process parameters and or control the process. However, such high-tier devices can be limited in their use for sensing because they are feature-rich with many capabilities and offer best-in-class performance but are typically more costly than can be justified for a wide-spread sensor network. Thus, there is a need for a low-cost solution that, when warranted, can be provided with certain additional features or functions. In this way, the overall cost of a system is that of a base device and any required option modules, without the cost of additional performance or functions.

### SUMMARY

A sensor device includes a sensor module housing, a sensor module, a communication module, and a universal interface. The sensor module housing is configured to contain the sensor module. The sensor module disposed in the sensor module housing. A communication module is operably coupled to the sensor module. The universal interface configured to couple to an option module to provide an additional function.

An extended sensor system is also provided. The extended sensor system includes a sensor module housing, a sensor module, a communication module, and an option module. The sensor module housing is configured to contain the sensor module. The sensor module is disposed in the sensor module housing. The communication module is operably coupled to the sensor module. The option module is interposed between the sensor module and the communication module and provides an additional function that is not provided by either the sensor module or the communication module.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view of a core sensor device with which embodiments described herein are particularly applicable.

FIG. 2 is a block diagram of an extended core sensor device in accordance with an embodiment of the present invention.

FIGS. 3A and 3B are diagrammatic exploded perspective and side elevation views, respectively, of an extended sensor system in accordance with an embodiment of the present invention.

FIG. 3C is a side elevation view of an extended sensor system in accordance with another embodiment of the present invention.

FIG. 4A is a side elevation view of an extended sensor system in accordance with another embodiment of the present invention.

FIG. 4B is a side elevation view of an extended sensor system in accordance with another embodiment of the present invention.

FIGS. 5-16 are block diagrams of various option modules that can be used in combination with a core sensor device to provide an extended sensor device in accordance with embodiments of the present invention.

### DETAILED DESCRIPTION OF ILLUSTRATIVE EMBODIMENTS

Embodiments described herein generally provide a core sensor device with an interface (both physical and electrical) that is configured to be coupled to an option module that provides a functionality or capability not present in the core sensor device. As used herein, a core sensor device is a device that includes a sensor module that is configured to couple to and transduce a particular type of sensor (such as a temperature sensor, pressure sensor, flow sensor, pH sensor, conductivity sensor, gas sensor, vibration sensor, et cetera) and a communication module that is coupled to the sensor module and communicates the sensed variable to one or more remote devices. Depending on the selection of the communication module, the communication may be in any suitable process communication protocol and may be wired, wireless, or both.

To create a cost effective, yet scalable, solution, embodiments described herein generally employ a modular approach. For sensor devices, a universal interface (physical and electrical) is employed that will accept a wide array of option modules that can be attached to best suit the application and end user needs. This allows an inexpensive core sensor device to be expanded in a cost-effective way without having to require a full re-design of the device.

Embodiments generally provide a core sensor device (sensor module and communication module) that includes a flexible digital and analog interface to allow for interchangeability between many foreseeable features and functions.

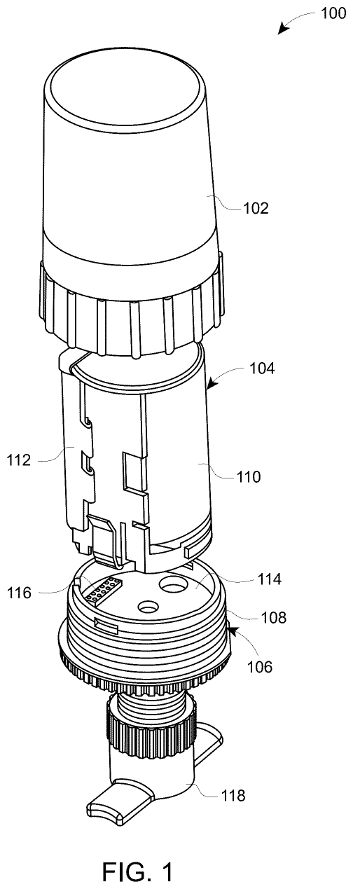

FIG. 1 is a diagrammatic perspective exploded view of a core sensor device with which embodiments described herein are particularly applicable. FIG. 1 shows core sensor device 100 having a cover 102 that is sized to slide over communication module 104 and engage threads 108 of sensor module housing 106. Communication module 104 is configured to support a power source, such as a battery 110, which may be rechargeable or non-rechargeable, as desired. An electronics housing portion 112 of communication module 104 contains electronic circuitry that is configured to communicate in a communication protocol, based on the selection of the type of communication module. Various different types of communication modules are provided having a similar physical size/shape and electrical interface characteristics, such that a core sensor device can be selected with one of a number of communication possibilities. Possible communication modules include, without limitation: WirelessHART process communication protocol (IEC62591); GPRS, UMTS, CDMA2000, LTE, LTE-M, NB-IoT, WiMax, 5G NR, and other protocols now used or later developed for cellular telephone networks; a WiFi standard, such as IEEE 802.11 b/g/n/a/ac/ax/bc; LoRaWAN protocol (ITU-T Y.4480); Bluetooth Low Energy; Highway Addressable Remote Transducer (HART®); FOUNDATION Fieldbus; and Profibus-PA.

FIG. 1 shows sensor module housing 106 containing a sensor module 114 which contains suitable electronic circuitry for interacting with a particular type of sensor and providing a digital indication of the sensor signal to the communication module through interface 116. In the illustrated example, sensor module 114 is a temperature sensor module that includes a temperature sensor (not shown) that senses a temperature of base 118, which may be clamped to a pipe or suitable curved surface. Other types of sensor modules can be used for the core sensor device in order to obtain other types of sensor signals. Examples include, without limitation: discrete I/O; level; corrosion; pressure; flow; and gas detection.

As can be appreciated, through selection of a particular sensor module and a particular communication module and coupling the two modules together, a wide variety of sensing/communication combinations are possible. Further, since these sensing and communication modules are relatively simple and inexpensive, they are well-suited for sensing applications. As used herein a core sensor device is a device formed by the coupling of a particular sensing module with a particular communication module.

In accordance with embodiments described herein, a core sensor device is provided with a universal interface that allows the core sensor device to couple to one or more option modules.

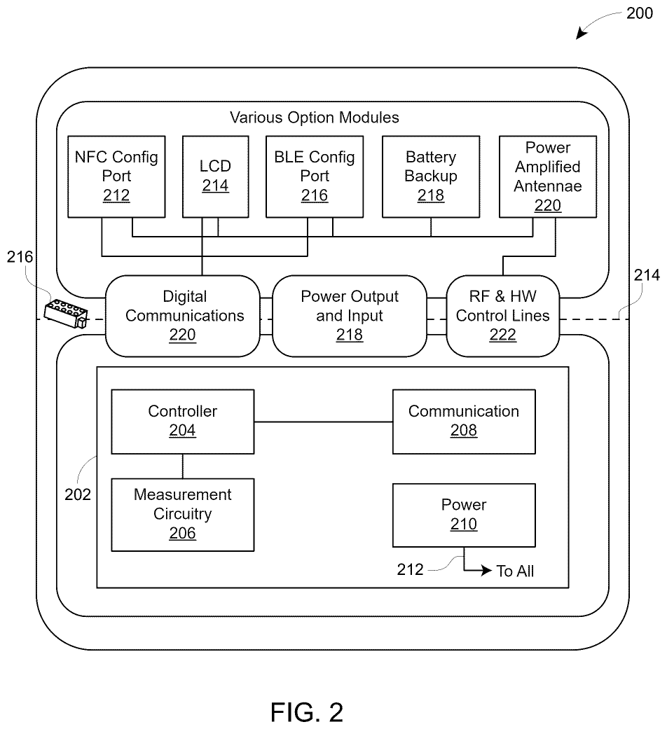

FIG. 2 is a block diagram of an extended sensor system in accordance with an embodiment of the present invention. Extended sensor system 200 includes a core sensor device 202 as described above. The core sensor device 202 includes a controller 204, measurement circuitry 206, communication circuitry 208, and power circuitry 210.

Controller 204 may be any suitable circuitry that is able to execute a number of programmatic steps or functions to interact with measurement circuitry 206 to obtain information indicative of a sensor reading and communicate, using communication module 208, the sensor reading to an external device. Controller 204 may be an application specific integrated circuit (ASIC), field programmable gate array (FPGA), microcontroller, or microprocessor. Controller 204 is configured, through hardware, software, or a combination thereof, to detect the coupling of one or more option modules 212, 214, 216, 218, and/or 220 and interact with the connected option module(s) to determine the capabilities and/or requirements of the connected option module.

Measurement circuitry 206 is coupled to controller 204 and provides an indication of a sensed measurement to controller 204. Measurement circuitry 206 may include suitable circuitry for measuring an analog electrical characteristic (e.g., resistance, voltage, current, et cetera) and providing a digital indication of the measured analog electrical characteristic to controller 204. Suitable examples of circuitry of measurement processing circuitry includes one or more analog-to-digital converters, one or more amplifiers, and or one or more multiplexers or switches.

Communication module 208 is coupled to controller 204 and provides controller 204 with the ability to communicate in accordance with a communication protocol that is selected based upon the selection of communication module 104. Examples of such communication include: WirelessHART process communication protocol (IEC62591); GPRS, UMTS, CDMA2000, LTE, LTE-M, NB-IoT, WiMax, 5G NR, and other protocols now used or later developed for cellular telephone networks; a WiFi standard, such as IEEE 802.11 b/g/n/a/ac/ax/be; LoRaWAN protocol (ITU-T Y.4480): Bluetooth Low Energy; Highway Addressable Remote Transducer (HART®); FOUNDATION Fieldbus; Ethernet-APL; and Profibus-PA.

Power module 210 is operably coupled to all components of the extended sensor system 200, as indicated by arrow 212 labeled “To All”. Power module 210 may include suitable power conditioning circuitry for filtering, limiting, stepping up or stepping down voltage, as required by various components of system 200. In one example, power module 210 includes a battery, such as a D-cell battery.

As shown in FIG. 2, a universal interface is provided on core sensor device 202. This universal interface 214 is represented diagrammatically by dashed line 214. In one example, universal interface is depicted as plastic connector 216 having a number of individual pin locations to receive a corresponding connector of an option module. The individual pins conduct various types of power 218, communications 220, and RF and hardware control lines 222. As can be seen in FIG. 2, some option modules may not need to be coupled to all of the lines of universal interface 214. As used herein, the term “lines” is intended to be broadly interpreted to include connections, circuits, connectors, conductors, traces, and wires. For example, battery backup module 218 need only connect to power output/input lines 218.

Interface 214 is developed to be a flexible digital and analog interface to allow for interchangeability. Interface 214 supports expansion for: RF improvements and amplification via an antenna connection along with control lines for enabling/disabling the output; power expansion connectivity to allow for extended capacity battery supply modules, rechargeable batteries, and hot standby supplies; digital communications to allow for bi-directional transfer of statis and/or dynamic data between the option modules and the core sensor device.

In most cases, the core sensor device will be the primary controller of all functions that relate to the option module(s) and its/their behavior. This allows for easy control regarding what options may be supported in the core sensor device for capability management.

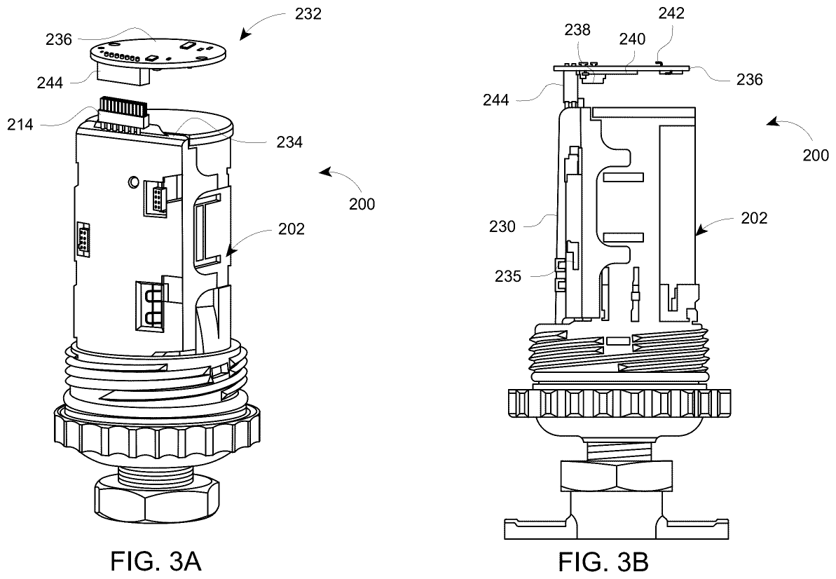

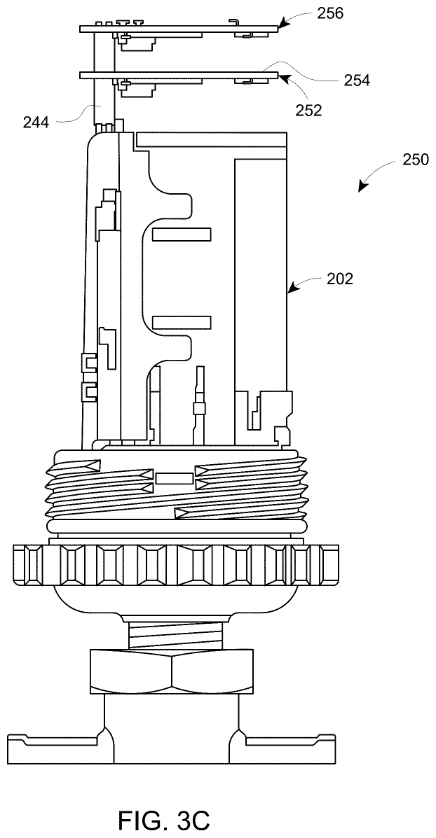

FIGS. 3A and 3B are diagrammatic exploded perspective and side elevation views, respectively, of an extended sensor system in accordance with an embodiment of the present invention. Extended sensor system 200 includes core sensor device 202. However, communication module 230 of core sensor device 202 includes universal interface 214 extending from surface 234 of communication module 230. Universal interface 214 is, in one embodiment, a right-angle connector that couples directly to circuit board 235 disposed within communication module 230. As shown in FIG. 3A, option module 232 is formed of a circuit board 236 having a number of electrical components 238, 240, and 242 disposed thereon. As can be seen, components may be disposed on opposite sides of circuit board 236. Option module 232 includes a connector 244 that mates with a corresponding connector of universal interface 214. When the connector 244 is coupled to universal interface 214, as shown in FIG. 3B, an extended sensor system is provided.

FIG. 3C is a side elevation view of an extended sensor system in accordance with another embodiment of the present invention. Extended sensor system 250 bears many similarities to extended sensor system 200, and like components are numbered similarly. For example, system 250 includes core sensor device 202. However, option module 252 includes a connector 244 that couples to universal interface 214 and also includes a connector on an opposite of circuit board 254 that allows an additional option module 256 to be coupled thereto. In this way, multiple option modules can be coupled to a core sensor device to provide a plurality of extended or additional functions to the core sensor device.

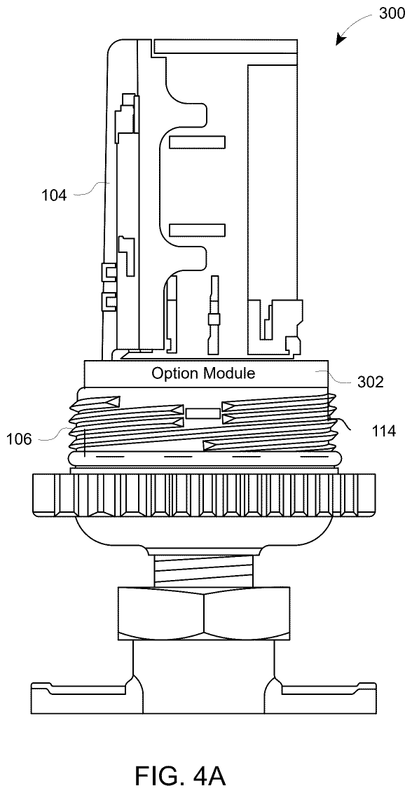

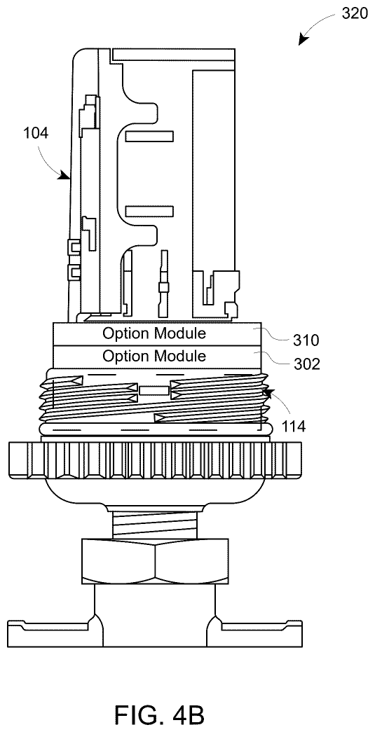

FIG. 4A is a side elevation view of an extended sensor system in accordance with another embodiment of the present invention. Extended sensor system 300 includes a sensor module 114 and a communication module 104. However, option module 302 is physically and electrically interposed between sensor module 114 and communication module 104. In this way, the electrical connection between sensor module 114 and communication module 104 is made by option module 302. Additionally, option module 302 is, in one embodiment, shaped like sensor module 114 such that option module 302 can be at least partially disposed within sensor module housing 106. In one example, option module 302 includes a passthrough connector that engages sensor module 114 and provides an additional connector on an opposite side thereof for engaging communication module 104.

FIG. 4B is a side elevation view of an extended sensor system in accordance with another embodiment of the present invention. Extended sensor system 320 includes a sensor module 114 and a communication module 104. However, the embodiment shown in FIG. 4B includes a plurality of option modules 302, 310, that are stacked, daisy-chained, or otherwise arranged to couple sensor module 114 to communication module 104 in such a way that adds the features and/or functionality of each of option modules 302, 310. The signals between the option modules 302, 310 and the core sensor device share a common flexible interface that allows for use of a variety of option modules. The interface can provide regulated voltage from the core sensor device for option module(s) that require power to operate. Additionally, the interface, in some embodiments, provides digital communications between the option module(s) and the core sensor device for data transfer. This includes such items as authentication, device configuration, sensor data transfer, et cetera.

Note, while the embodiments shown in FIGS. 4A and 4B provide option modules that are interposed between a sensor module and a communication module, it is expressly contemplated that such embodiments can be used in combination with that shown in FIGS. 3A-3C, which provide a universal interface on the communication module. Thus, not only may option modules be stacked or daisy-chained between sensor module and communication module, but they may also be stacked or daisy chained to the communication module. Additionally, it is expressly contemplated that embodiments described herein can employ an extended length cover 102 (shown in FIG. 1) to accommodate use of one or more option modules.

In some examples, the controller of the core sensor device is the controller of the extended sensor system with respect to all functions that relate to the option module and its behavior. For example, the controller of the core sensor device may detect the coupling or presence of the option module and check the option module for compatibility and allow the user to unlock or otherwise enable functionality of the option module. Preferably, the common connection/universal interface supports plug-and-play connectivity between the core sensor device and the option module(s). Additionally, it is expressly contemplated that keying features may be used in the connectors and/or physical configuration of the option modules to ensure that only certain combinations of option modules are allowed.

As set forth above, option modules may take the form of a circuit board and connector or as an assembly that couples the sensor module to the communication module. The following examples of option modules, accordingly, may take either form.

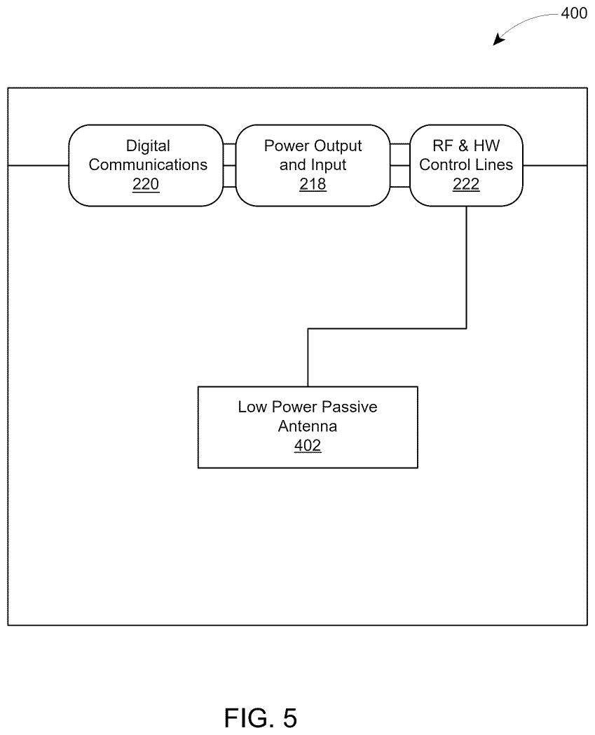

FIG. 5 is a block diagram of an option module in accordance with an embodiment of the present invention. As can be seen, option module 400 includes a low power passive antenna 402 that couples to one or more radio-frequency and hardware control lines 222 of the universal interface. By providing low-power passive antenna 402, the extended sensor system may enjoy improved radio-frequency range and/or connectivity.

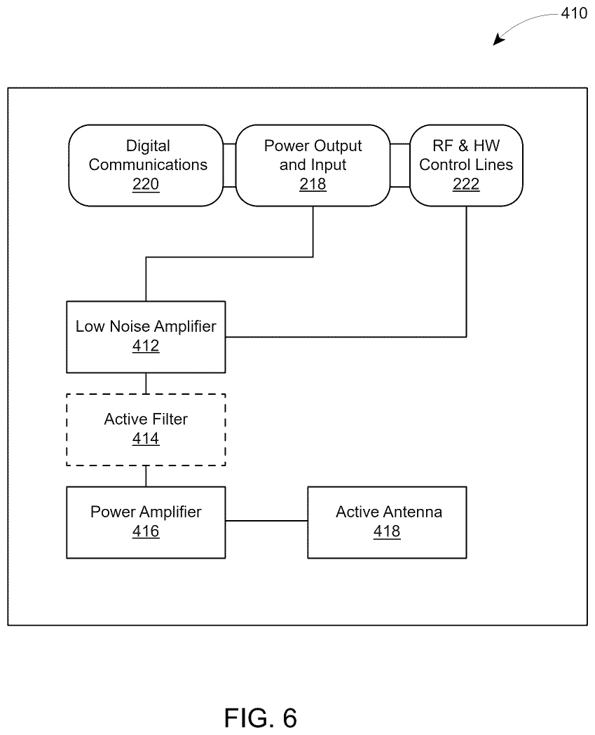

FIG. 6 is a block diagram of an option module in accordance with another embodiment of the present invention. As can be seen, option module 410 includes a low noise amplifier, optional active filter 414, power amplifier 416, and active antenna 418. Active components of option module 410 draw regulated power from power input/output lines 218, while one or more RF and hardware control lines are coupled to low power noise amplifier 412. Optional active filter 414 is shown in phantom as some embodiments may not need such active filtering. Providing option module 410 with the illustrated components supports active antenna 418 and improves signal to noise ratio (SNR) while also improving receive sensitivity.

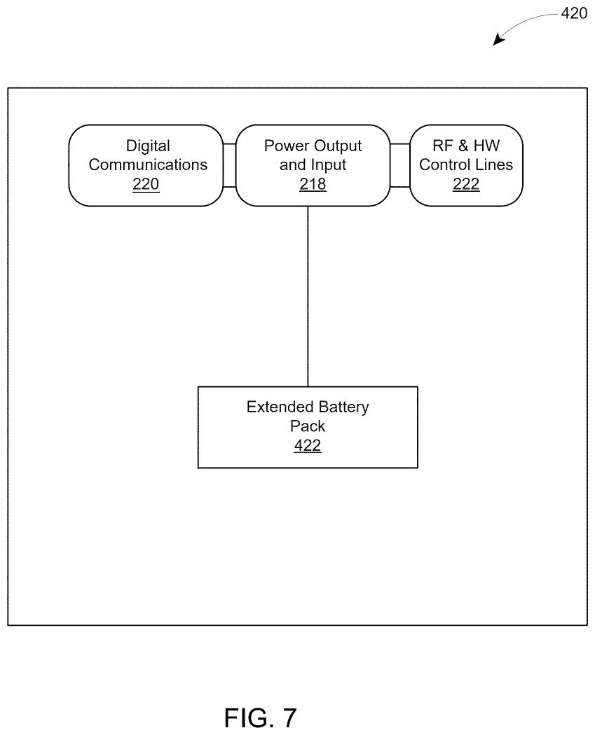

FIG. 7 is a block diagram of an option module in accordance with another embodiment of the present invention. As can be seen, option module 420 includes an extended battery pack 422 coupled to power input/output lines 218. By providing extended battery pack 422, the extended sensor system may enjoy longer operation before running out of power.

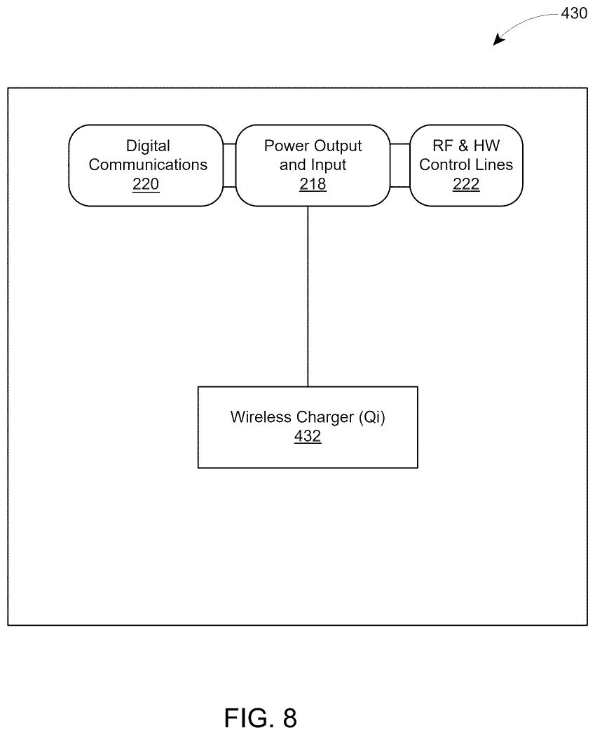

FIG. 8 is a block diagram of an option module in accordance with another embodiment of the present invention. As can be seen, option module 430 includes wireless charger 432 coupled to power input/output lines 218. For embodiments of the sensor system that employ a rechargeable battery, wireless charger 432 allows the rechargeable battery to be recharged in the field or while the extended sensor system is operating. In one embodiment, wireless charger 432 is a Qi charger. Qi charging works on the principle of electromagnetic induction. The charging pad and a device include wire coils. The charging pad has a large coil, while the device to be charged generally has a smaller one. When current flows into the charging pad, its large coil generates a magnetic field that interacts with the smaller coils of the device to be charged to generate electricity in the smaller coils.

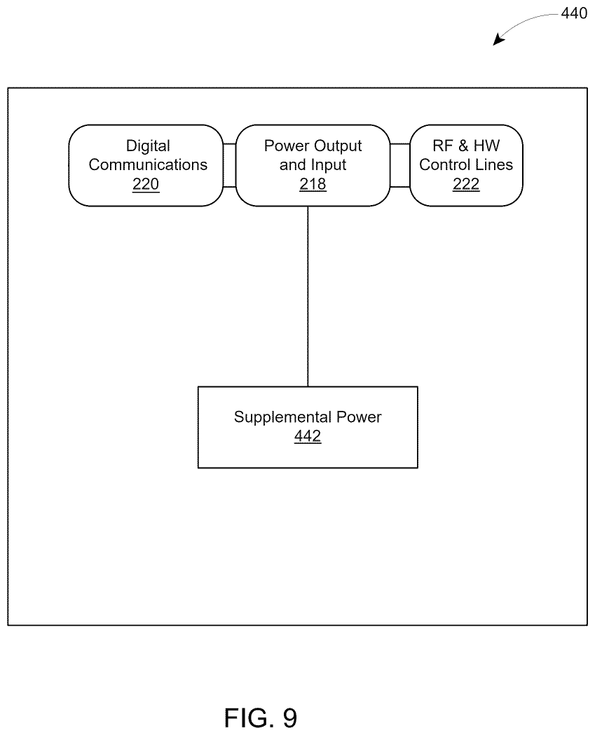

FIG. 9 is a block diagram of an option module in accordance with another embodiment of the present invention. As can be seen, option module 440 includes supplemental power module 442 coupled to power input/output lines 218. Supplemental power module 442 contains a relatively small quantity of power compared to the primary battery of the system. However, it is able to provide sufficient power to operate the extended sensor system while the primary battery is changed, thereby allowing the extended sensor system to remain online while the battery change occurs.

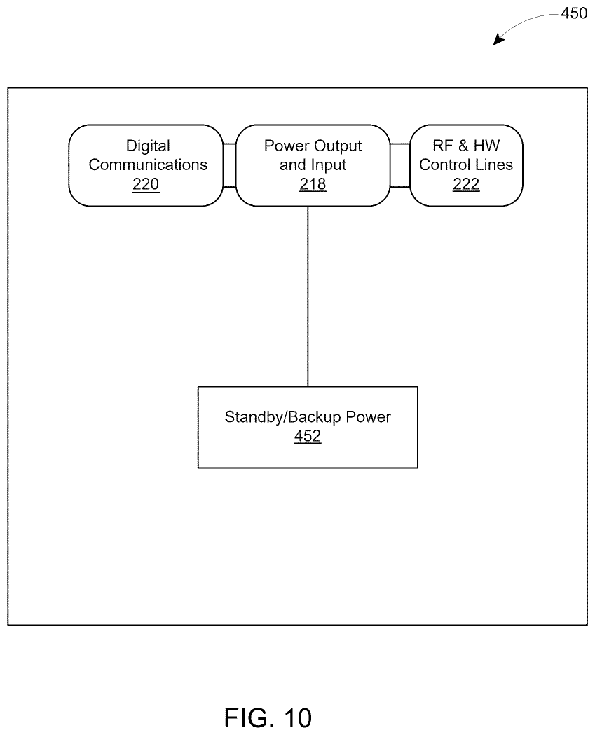

FIG. 10 is a block diagram of an option module in accordance with another embodiment of the present invention. As can be seen, option module 450 includes standby/backup power module 452 coupled to power input/output lines 218. Standby/backup power module 452 provides a standby capability using a small backup battery that activates when the primary cell is depleted or falls below a certain power threshold.

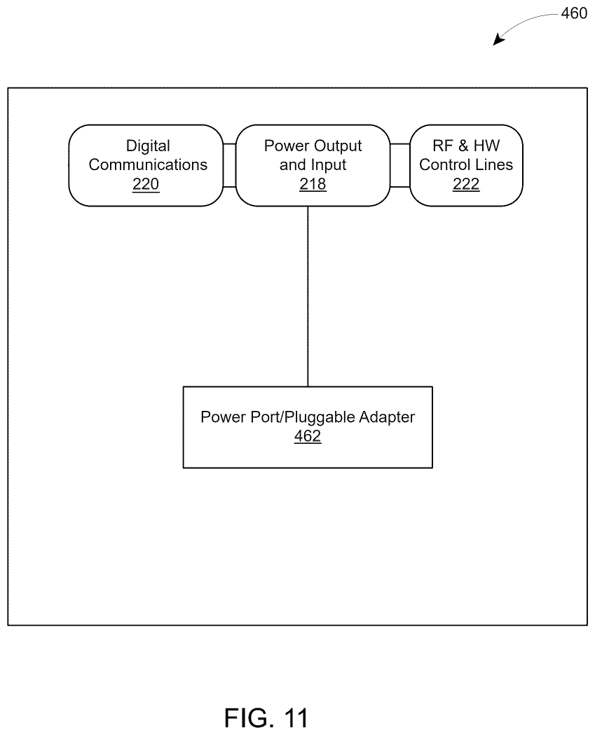

FIG. 11 is a block diagram of an option module in accordance with another embodiment of the present invention. As can be seen, option module 460 includes power port/pluggable adapter 462 coupled to power input/output lines 218. Power port/pluggable adapter 462 allows for a wired power supply to power the extended sensor system.

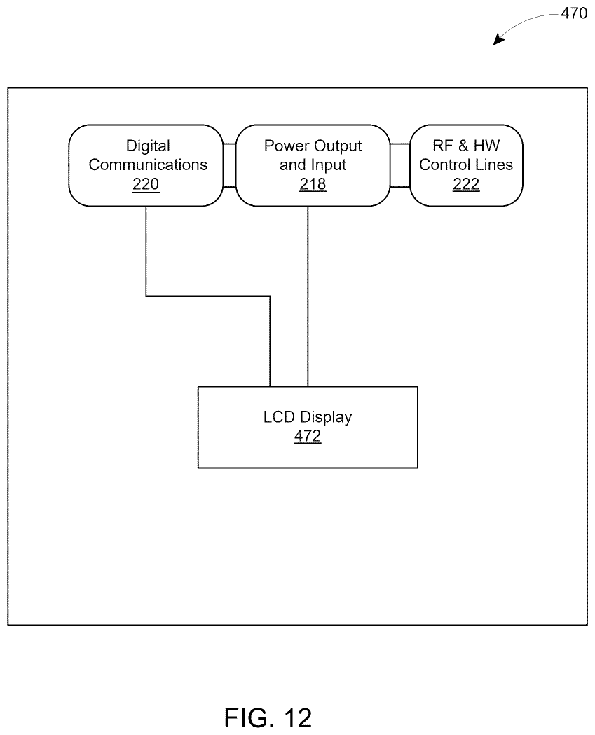

FIG. 12 is a block diagram of an option module in accordance with another embodiment of the present invention. As can be seen, option module 470 includes a display 472 (such as an LCD display, LED display, e-ink display, vacuum fluorescent display, OLED display, or other suitable display) coupled to power input/output lines 218 and digital communication lines 220. Display 472 can display sensor data as well as local status information, such as device health, battery power level, RF link quality, et cetera.

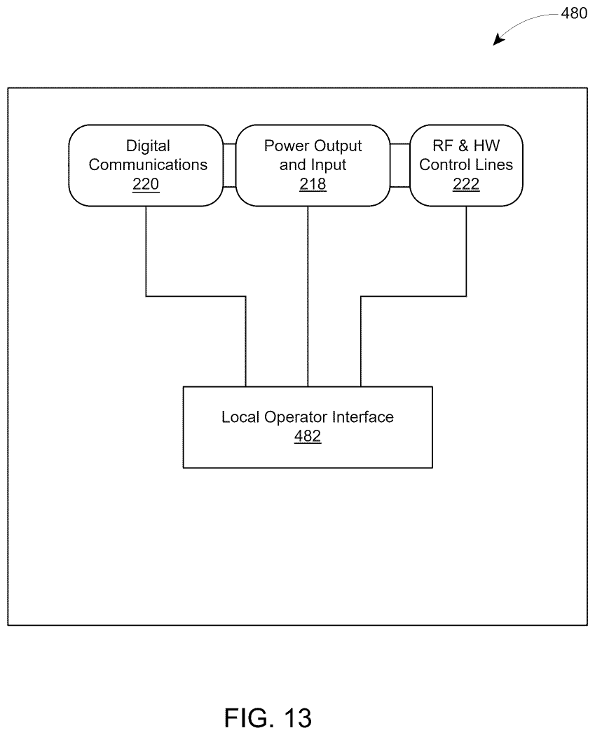

FIG. 13 is a block diagram of an option module in accordance with another embodiment of the present invention. As can be seen, option module 480 includes local operator interface module 482 coupled to power input/output lines 218, digital communication lines 220, and RF and hardware control lines 222. A local operator interface includes any form of display, such as LCD, LED, e-ink, vacuum fluorescent display (VFD), et cetera and/or any suitable button(s), knob(s), slider(s), joystick(s), touchscreen, et cetera for receiving user input. Local operator interface module 482 supports displaying sensor data, status information, configuration data. Additionally, local operator interface module 482 also supports local configuration, such as sensor trim.

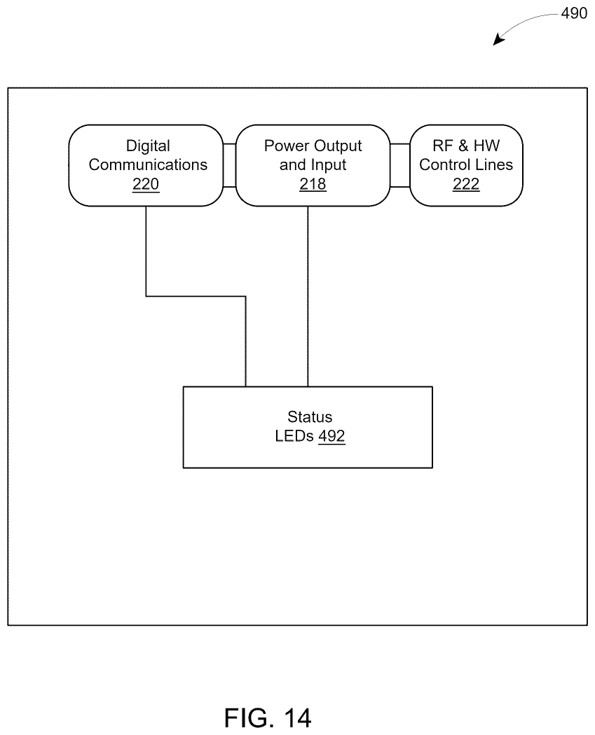

FIG. 14 is a block diagram of an option module in accordance with another embodiment of the present invention. As can be seen, option module 490 includes Status LEDs 492 coupled to power input/output lines 218 and digital communication lines 220. Status LEDs 492 can display status information such as battery status, wireless connection status, and overall device or sensor health. This information may be communicated using a color of the LED (green=good, amber=questionable, red=bad) and/or flash codes. However, embodiments can be practiced where simply energizing an LED is indicative of a particular status, such as RF link present.

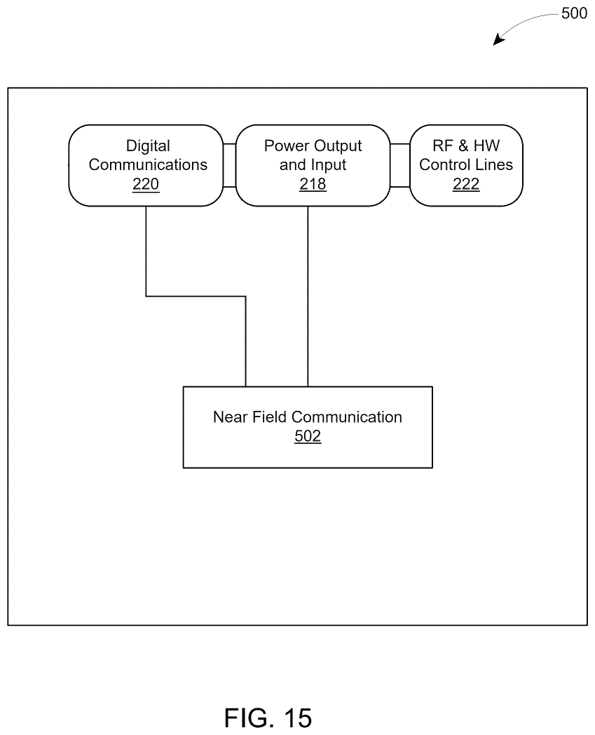

FIG. 15 is a block diagram of an option module in accordance with another embodiment of the present invention. As can be seen, option module 500 includes Near Field Communication module 502 coupled to power input/output lines 218 and digital communication lines 220. Near field communication module 502 supports using near-field communication for sending and receiving data when the user is next to the extended sensor system with another NFC device. This near-field communication can be used for local configuration of the extended sensor system and/or for data/status monitoring without the need to remove cover 102 from the system. The ability to interact with the device without removing the cover is useful in highly volatile or explosive environments, where a hot work permit may be required.

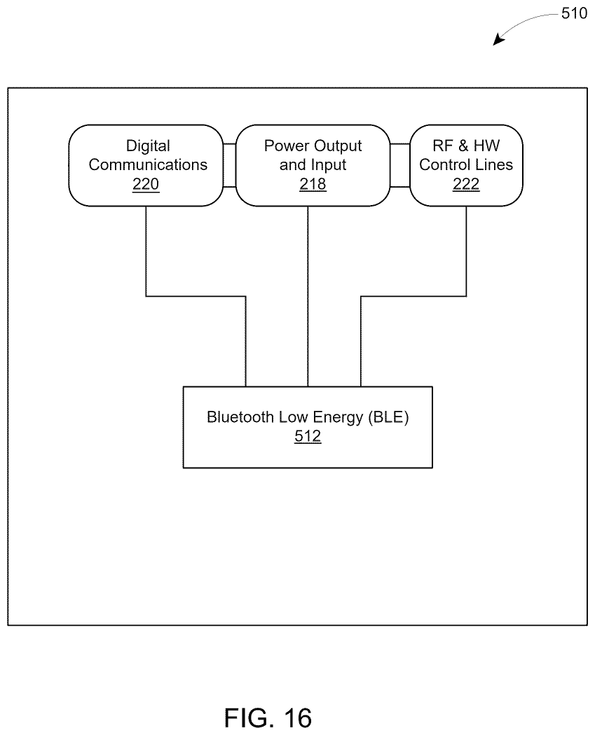

FIG. 16 is a block diagram of an option module in accordance with another embodiment of the present invention. As can be seen, option module 510 includes Bluetooth Low Energy (BLE) Communication module 512 coupled to power input/output lines 218, digital communication lines 220, and RF and hardware control lines 222. BLE module 512 supports using Bluetooth communication for sending and receiving data to/from other BLE-enabled devices. This BLE communication can be used for local configuration of the extended sensor system and/or for data/status monitoring without the need to remove cover 102 from the system.

Although the present invention has been described with reference to preferred embodiments, workers skilled in the art will recognize that changes may be made in form and detail without departing from the spirit and scope of the invention.

What is claimed is:

1. A sensor device comprising:
a sensor module housing configured to contain a sensor module;
a sensor module disposed in the sensor module housing;
a communication module operably coupled to the sensor module; and
a universal interface configured to couple to an option module to provide an additional function.

2. The sensor device of claim 1, wherein the universal interface is disposed on the communication module.

3. The sensor device of claim 2, wherein the universal interface includes a connector coupled to a circuit board of the communication module.

4. The sensor device of claim 3, wherein the connector is a right-angle connector.

5. The sensor device of claim 1, and further comprising a first option module coupled to the universal interface, the first option module providing an additional function that is not provided by either the sensor module or the communication module.

6. The sensor device of claim 5, wherein the first option module is embodied as a circuit board having a connector coupled to the universal interface.

7. The sensor device of claim 5, wherein the first option module includes a display.

8. The sensor device of claim 7, wherein the display is an LCD display.

9. The sensor device of claim 7, wherein the display includes at least one LED.

10. The sensor device of claim 5, wherein the first option module includes a local operator interface.

11. The sensor device of claim 5, wherein the first option module includes a power source.

12. The sensor device of claim 11, wherein the power source is configured to provide backup power.

13. The sensor device of claim 11, wherein the power source is configured to provide supplemental power.

14. The sensor device of claim 11, wherein the power source is a charger.

15. The sensor device of claim 14, wherein the charger is a wireless charger.

16. The sensor device of claim 5, wherein the first option module includes a radio-frequency component.

17. The sensor device of claim 16, wherein the radio-frequency component is selected from the group consisting of: a passive antenna, an active antenna, a near-field communication module, and a Bluetooth Low Energy (BLE) module.

18. The sensor device of claim 5, wherein the first option module includes a component selected from the group consisting of: a low noise amplifier, an active filter, and a power amplifier.

19. The sensor device of claim 6, wherein the circuit board includes a connector on an opposite side of the circuit board than the connector coupled to the universal interface.

20. The sensor device of claim 19, and further comprising a second option module operably coupled to the sensor device through the connector on the opposite side of the circuit board of the first option module.

21. The sensor device of claim 20, wherein the second option module provides an additional function that is not provided by either the sensor module, the communication module, or the first option module.

22. The sensor device of claim 1, wherein the universal interface includes digital communication lines, power lines, and radio-frequency and hardware control lines.

23. An extended sensor system comprising:
a sensor module housing configured to contain a sensor module;
a sensor module disposed in the sensor module housing;
a communication module operably coupled to the sensor module; and
an option module interposed between the sensor module and the communication module, the option module providing an additional function that is not provided by either the sensor module or the communication module.

24. The extended sensor system of claim 23, wherein the option module is configured to be at least partially disposed within the sensor module housing.

25. The extended sensor system of claim 23, wherein the option module includes a power source.

26. The extended sensor system of claim 25, wherein the power source is configured to provide backup power.

27. The extended sensor system of claim 25, wherein the power source is configured to provide supplemental power.

28. The extended sensor system of claim 25, wherein the power source is a charger.

29. The extended sensor system of claim 28, wherein the charger is a wireless charger.

30. The extended sensor system of claim 23, wherein the option module includes a radio-frequency component.

31. The extended sensor system of claim 30, wherein the radio-frequency component is selected from the group consisting of: a passive antenna, an active antenna, a near-field communication module, and a Bluetooth Low Energy (BLE) module.

32. The extended sensor system of claim 23, wherein the option module includes a display.

33. The extended sensor system of claim 32, wherein the display is an LCD display.

34. The extended sensor system of claim 32, wherein the display includes at least one LED.

35. The extended sensor system of claim 23, wherein the option module includes a local operator interface.

36. The extended sensor system of claim 23, wherein the option module includes a component selected from the group consisting of: a low noise amplifier, an active filter, and a power amplifier.

37. The extended sensor system of claim 23, and further comprising a second option module interposed between the option module and the communication module, wherein the second option module provides an additional function not provided by sensor module, communication module, and first option module.
